(19) United States
(12) Patent Application Publication
(10) Pub. No.: US 2021/0244979 A1
(43) Pub. Date: Aug. 12, 2021

(54) FIRE SUPPRESSION SYSTEM AND METHOD

(71) Applicant: Front Line Only LLC, Cheyenne, WY (US)

(72) Inventors: William Gary London, II, Upland, CA (US); Douglas Wood Redmond, Debary, FL (US); Kyle Mitchell Kersh, Orlando, FL (US); Brian Tad Kornoelje, Cypress, CA (US)

(21) Appl. No.: 17/173,020

(22) Filed: Feb. 10, 2021

Related U.S. Application Data
(60) Provisional application No. 62/975,094, filed on Feb. 11, 2020.

(51) Int. Cl. A62C 3/02; A62C 37/38; A62C 37/44

(52) U.S. Cl. CPC A62C 3/0271; A62C 3/0292; A62C 37/44; A62C 37/38

(57) ABSTRACT

Systems and methods are disclosed for fire suppression. One method of fire suppression may include sensing initial environmental parameters in an area of interest, and determining whether or not to enable the fire suppression system, based at least in part on the sensed initial parameters. Then subsequently sensing subsequent environmental parameters, and determining whether to enable or disable the fire suppression system, based at least in part on the sensed subsequent environmental parameters.

### CROSS-REFERENCE TO RELATED APPLICATION

This application claims the benefit under 35 U.S.C. § 119(e) of U.S. Provisional Patent Application No. 62/975,094 filed on Feb. 11, 2020, which is hereby incorporated herein by reference for all that it discloses.

### TECHNICAL FIELD

The present disclosure relates to systems and methods for preventing wildfires, and more particularly to automated systems and methods for wildfire prevention, detection, control and suppression by and through a plurality of environmental sensors.

### BACKGROUND OF THE INVENTION

Those of skilled in the art know that a wildfire is an uncontrolled fire in an area of combustible vegetation. Wildfires can be characterized in terms of the cause of ignition, their physical properties, the combustible material present, and the effect of weather on the fire. Wildfires can cause damage to property and human life. In parts of the United States, especially the western United States, the wildfire season has lengthened due to rising temperatures and snow melting earlier in the season. Elevated temperatures dry out vegetation, which then acts as a tinderbox for fires. Despite the risks wildfires pose to homes and lives, housing growth in once sparsely settled areas near forests and other vegetation has also increased rapidly, leading to more wildfires from human-caused ignitions and more loss of property. Whether ignited by human activity or lightning strikes, there's a greater likelihood of fires burning out of control. As these conditions worsen, the overall burned area expands.

Wildfires occur when all the necessary elements of a fire come together in a susceptible area: an ignition source is brought into contact with a combustible material such as vegetation, which is subjected to enough heat and has an adequate supply of oxygen from the ambient air. Less dense material such as grasses and leaves are easier to ignite because they contain less water than denser material such as branches and trunks. Steep slopes and wind can accelerate the rate of spread.

Most of us have seen the “Fire Danger” signs at the entrances to national forests and national parks, which show color coded fire level danger, from Low (green) all the way to Extreme (red). These conditions are based on several factors. One of which is relative humidity. At 15% relative humidity, the fire danger is immediately Extreme (red). If the wind speed increases, the fire danger level may increase. The fire danger level will be decreased from extreme to low when one inch of rain falls over 90 minutes in a given area.

Another factor in the fire danger level is the fuel rating. The fire services rate all of the things that can burn in a wildfire as follows: dead fuel, one-hour fuels, ten-hour fuels, 100-hour fuels, etc. Dead fuel includes matter that is immediately ready to burn. A one-hour fuel will be ready to burn after one hour of sunshine. A ten-hour fuel will be ready to burn after ten hours of sunshine, etc. This is the reason for a 10 am local time deadline on containment of fires. If is not contained by then, it will go uncontained for at least another day.

During certain times a year, plants stop growing and start dying. When the relative humidity goes below 24%, plants may emit gaseous volatile organic compounds (VOCs). When VOCs are present, a spark from static electricity may ignite an area, and dead fuels ignite, and quickly grow into a wildfire. When it rains in an area, a spring-like weather condition is created in that area, and plants will begin to green.

Wildfire prevention refers to the preemptive methods aimed at reducing the risk of fires as well as lessening its severity and spread. Prevention techniques aim to manage air quality, maintain ecological balances, protect resources, and to affect future fires. North American firefighting policies permit naturally caused fires to burn to maintain their ecological role, so long as the risks of escape into high-value areas are mitigated. However, prevention policies must consider the role that humans play in wildfires, since people are building more and more in areas where wildfires are possible and prevalent.

Strategies for wildfire prevention, detection, control and suppression have varied over the years. One common and inexpensive technique is controlled burning: intentionally igniting smaller fires to minimize the amount of flammable material available for a potential wildfire. This method may be problematic when the controlled burn becomes uncontrollable, and a wildfire ensues. What is needed is a better, proactive system for wildfire prevention.

### SUMMARY OF THE INVENTION

Accordingly, the present invention provides various embodiments of systems and methods for fire suppression. One method may include sensing one or more initial environmental parameters in an area of interest, wherein the sensing is performed by one or more sensors positioned within the area of interest. The one or more initial environmental parameters are then recorded in the area of interest, and the fire suppression system is engaged if the one or more initial environmental parameters reach a pre-determined threshold. The engagement of the system is based at least in part on the one or more sensed initial environmental parameters. This preferred embodiment also includes sensing one or more subsequent environmental parameters in the area of interest, recording the one or more subsequent environmental parameters in the area of interest, comparing the one or more subsequent environmental parameters in the area of interest against the one or more initial environmental parameters in the area of interest, and obtaining one or more differential numerical values, if any, of the environmental parameters after the comparison of the one or more subsequent environmental parameters in the area of interest is made against the one or more initial environmental parameters in the area of interest. In this preferred embodiment, it is then determined whether to continue engaging the fire suppression system based at least in part on the one or more differential numerical values of the environmental parameters.

The Summary is neither intended nor should it be construed as being representative of the full extent and scope of the present disclosure. The present disclosure is set forth in various levels of detail in the Summary, as well as in the attached drawings and the Detailed Description, and no limitation as to the scope of the present disclosure is intended by either the inclusion or non-inclusion of elements, components, etc. in this Summary. Additional aspects of the present disclosure will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present disclosure are possible utilizing, alone or in combination, as set forth above and/or described in the accompanying figures and/or in the description herein below. Further details and other features will become apparent after review of the following Detailed Description and accompanying drawing figures.

### BRIEF DESCRIPTION OF THE DRAWINGS

Example embodiments are illustrated in referenced figures of the drawing. It is intended that the embodiments and figures disclosed herein are to be considered illustrative rather than limiting.

FIG. 1 illustrates is a method of fire suppression, according to a preferred embodiment.

FIG. 2 illustrates a fire suppression system, according to a preferred embodiment.

FIG. 3 illustrates a fire suppression system, according to a preferred embodiment.

FIG. 4 illustrates a fire suppression system, according to a preferred embodiment.

FIG. 5 illustrates a fire suppression system, according to a preferred embodiment.

FIG. 6 illustrates a fire suppression system, according to a preferred embodiment.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

### DETAILED DESCRIPTION

The present invention provides its benefits across a broad spectrum of endeavors. It is applicant's intent that this specification and the claims appended hereto be accorded a breadth in keeping with the scope and spirit of the invention being disclosed despite what might appear to be limiting language imposed by the requirements of referring to the specific examples disclosed. Thus, to acquaint persons skilled in the pertinent arts most closely related to the present invention, a preferred embodiment of the system is disclosed for the purpose of illustrating the nature of the invention. The exemplary method of installing, assembling and operating the system is described in detail according to the preferred embodiment, without attempting to describe all of the various forms and modifications in which the invention might be embodied. As such, the embodiments described herein are illustrative, and as will become apparent to those skilled in the art, can be modified in numerous ways within the scope and spirit of the invention, the invention being measured by the appended claims and not by the details of the specification.

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, subparagraph (f).

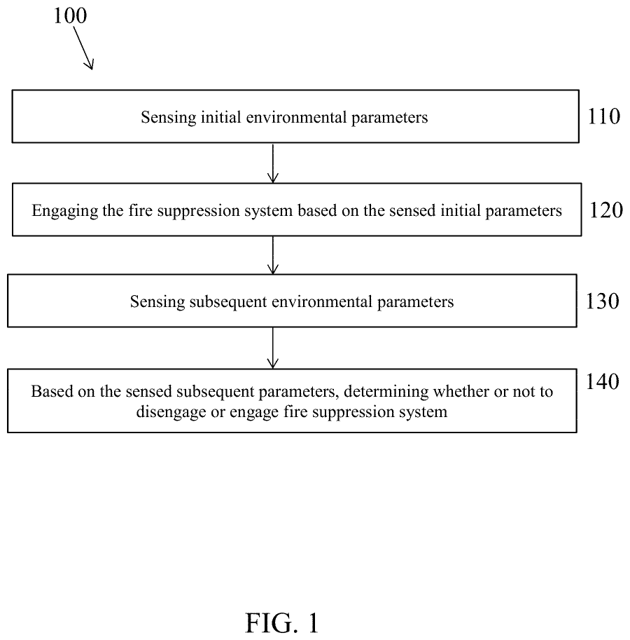

FIGS. 1-6 and the following description depict specific examples of the invention to teach those skilled in the art how to make and use the invention. For the purpose of teaching inventive principles, some conventional aspects have been simplified or omitted. Those skilled in the art will appreciate variations from these embodiments that fall within the scope of the invention. Those skilled in the art will appreciate that the features described below can be combined in various ways to form multiple embodiments and variations of the invention. As a result, the invention is not limited to the specific embodiments described below, but only by the claims and their equivalents.

The present disclosure is directed to a pro-active fire suppression system and method for areas near dwellings. The proactive design may give firefighters and the rest of the community a strategic advantage to prevent destruction of property and loss of life. The system may mimic weather, which inhibits fires, by wetting fuels, increasing the relative humidity, and lowering the temperature in the area of interest.

FIG. 1 illustrates a sample method 100 for fire suppression. Method 100 includes sensing initial environmental parameters in an area of interest 110, engaging a fire suppression system if it is determined fire suppression is needed, wherein the determining is based at least in part on the sensed initial environmental parameters, 120, sensing subsequent environmental parameters in an area of interest 130, and determining to engage or disengage the fire suppression system based at least in part on the sensed subsequent environmental parameters 140.

Some preferred embodiments may also include recording the one or more initial environmental parameters in the area of interest, recording the one or more subsequent environmental parameters in the area of interest, and comparing the one or more subsequent environmental parameters in the area of interest against the one or more initial environmental parameters in the area of interest. In these preferred embodiments, one or more differential numerical values are obtained after the comparison of the one or more subsequent environmental parameters in the area of interest is made against the one or more initial environmental parameters in the area of interest. After this analysis, a determination can be made as to whether to continue engaging or disengage the fire suppression system.

Sensing 110 may include sensing initial environmental parameters, such as humidity, wind speed, temperature, presence of flames, amount of volatile organic compounds, amount of particulate, and/or other parameters, and/or combinations thereof.

The area of interest may include a 50 to a 5,000 foot radius around a home, dwelling or other structure, or area to be protected by the system. This may depend on the terrain, fuel availability, environmental parameters, etc.

Engaging 120 may include engaging a fire suppression system if it is determined fire suppression is needed, wherein the determining is based at least in part on the sensed initial environmental parameters. The system may be engaged when conditions are right for the ignition and spread of wildfires. The sensors may detect VOCs in the air that may, in some circumstances, be released by plants. In some preferred embodiments, the sensors may also sense temperature, wind speed, and humidity. In these preferred embodiments, the system is ready to engage when high fire conditions exist. Engaging the system may turn dead fuels into one-hour fuels, one-hour fuels into ten-hour fuels, etc.

In some preferred embodiments, the system may engage when the relative humidity of the area of interest falls below 15%, or the system may engage when the wind speed rises to 20 mph or greater, regardless of the presence of fire. The system may also engage when the ambient temperature rises above a certain level, such as 100-150 degrees F. This pro-active method may decrease the likelihood of a fire starting, and may also decrease the likelihood of a fire spreading into the area of interest. This pro-active system may be used many times throughout a fire season to inhibit fires starting or spreading in the area of interest.

In some preferred embodiments, flame sensors may be used to engage or activate the system immediately. In these preferred embodiments, this activation may cause the system to dispense fire retardant foam in the area of interest. In some preferred embodiments, the system may be activated remotely if smoke is seen or detected, i.e. a fire break on demand system.

Those skilled in the art know that environmental conditions create fire danger in certain areas. The disclosed system and methods changes the environmental parameters to lower fire risk. The system may slow down or inhibit a wildfire to give firefighters and others more time to respond effectively

Sensing 130 may include sensing environment conditions, which are then analyzed against predetermined environmental parameters. In preferred embodiments, the environmental parameters analyzed include humidity, wind speed, temperature, presence of flames, amount of volatile organic compounds, amount of particulate, and/or other parameters, and/or combinations thereof.

Determining 140 may include determining to engage or disengage the fire suppression system based at least in part on the sensed environmental parameters. If the system was previously engaged, the determination may be made to disengage the system, based at least in part on the sensed environmental parameters. In an example, this may be when the temperature is lowered a certain amount or to a certain temperature. This may also be when the relative humidity is raised a certain amount or to a certain level, such as above 15-20%.

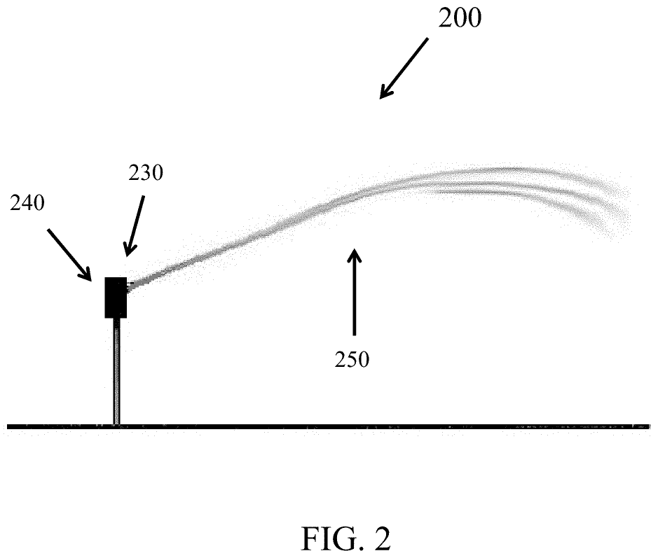

FIG. 2 illustrates a portion of a system 200 for fire suppression, according to an example. System 200 includes an outlet, sprinkler, sprayer, or other device 230 for dispensing fire-retardant material. Sprayer 230 may be mounted on a tower or stanchion such that fire retardant may be dispensed at a throw distance 250. In this example the throw distance is approximately 70 feet, and an angle 240 of about 27 degrees from horizontal. It will be appreciated that other distances, risers, riser heights, and angles may be used based on the desired characteristics of the system, and based upon the geography and/or topography in which the area of interest is location.

With a throw radius of about 70 feet, each station 230 may provide coverage of about 15,000 square feet. So a system with 6 stations can cover an area of about 2.1 acres. If each station can disperse 30 gpm, that would provide 0.56 inch of moisture per hour per station. If the 20,000 gallon tank is full, that would allow the system to disperse about an inch of moisture to the entire area of interest over about an hour and forty-five minutes.

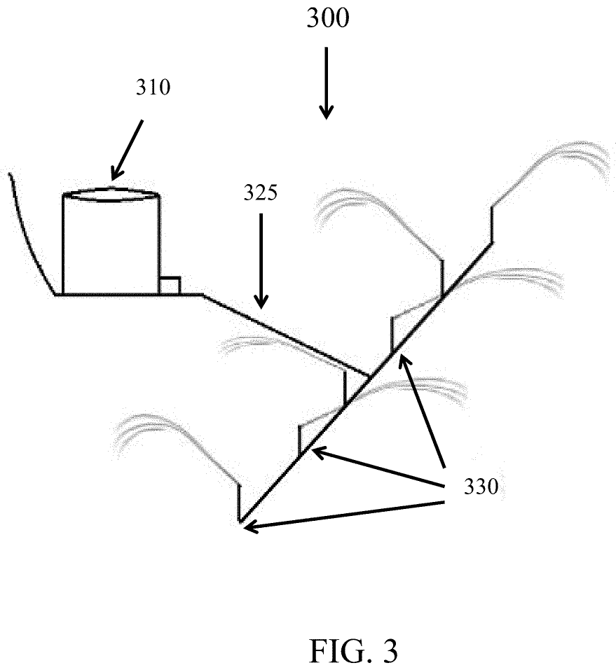

FIG. 3 illustrates a portion of a system 300 for fire suppression, according to an example. This example shows a gravity fed system where the fire suppression material may be fed through a distribution system 325 to six dispersing stations 330.

System 300 includes a vessel or tank 310, to hold fire suppression material. Tank 310 may be a 20,000 gallon poly tank for water storage. Larger or smaller tanks may be used, based on the area of interest and other considerations. System 300 may include another tank connected to the distribution system with foam in the tank.

This system may operate optimally with at least 30 gpm of flow through the distribution system 325. This may be accomplished by having at least a 100 foot drop from the vessel 310 to the outlets 330. Other designs may be used depending on the outlet gpm and other consideration.

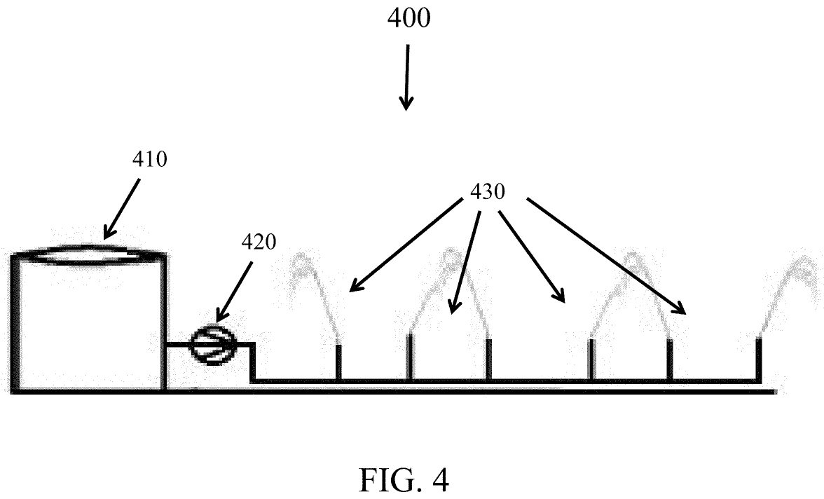

FIG. 4 illustrates a portion of a system 400 for fire suppression, according to an example. This example shows a pump fed system where the fire suppression material may be fed through a distribution system to six dispersing stations 430. System 400 may include a tank 410, pump 420, and six dispersing devices 430.

In some preferred embodiments, pump 420 may be a 1-10 hp electric pump that runs on 120 VAC or 6 VDC. Pump 420 may also be a gas powered pump, depending on design and other considerations.

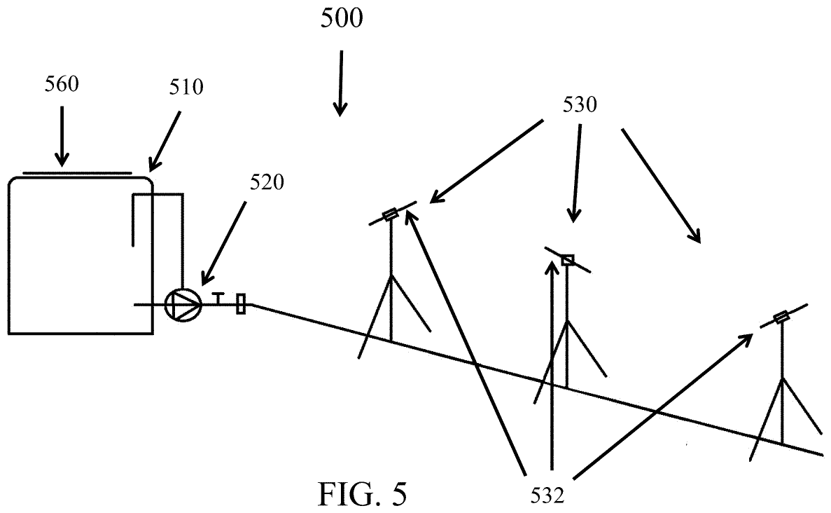

FIG. 5 illustrates a portion of a system 500 for fire suppression, according to an example. This example shows a pump fed system where the fire suppression material may be fed through a distribution system to three dispersing stations 530. System 500 may include a tank 510, pump 520, dispersing devices 530, and powering systems 532, 560.

Powering system 532 may be used to power the dispersing devices 530. Powering system 532 may be used to start and power the pump 520. In some preferred embodiments, power systems 532, 560 may include solar panel, batteries, controller, and all other devices and systems to store and release power to power the system without having to run a power line to the system. This may be advantageous in rural areas where it is expensive to get a conventional power line to the system.

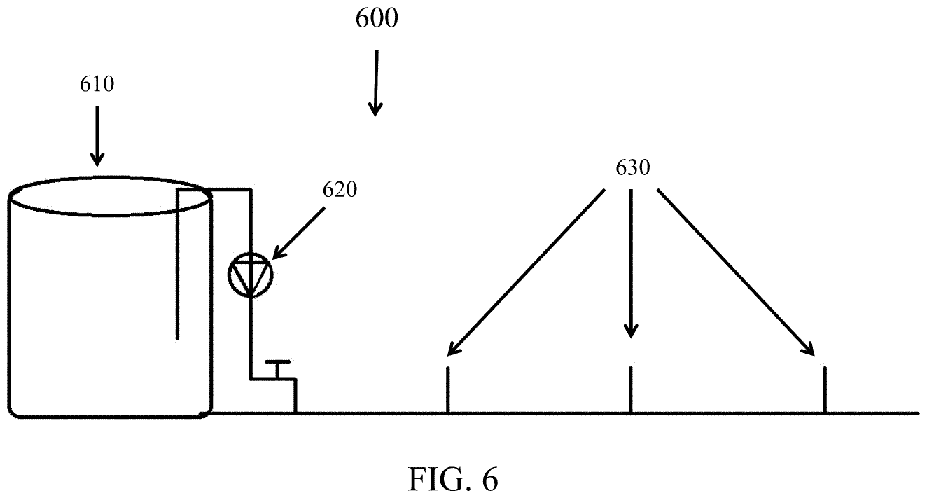

FIG. 6 illustrates a portion of a system 600 for fire suppression, according to an example. This example shows a pump fed system on relatively level ground, where the fire suppression material may be fed through a distribution system to three dispersing stations 630. System 600 may include a vessel 610, pump 620, and dispersing stations 630.

Fire suppression material may include water, foam retardant, and other fire suppression materials. In some embodiments, more than one tank may be used with different fire suppression material in each tank. The system may then allow different fire suppression materials to be used for different conditions, such as using water proactively, and foam when flames are detected.

All directional references (e.g. top, bottom, front, back) are only used for identification purposes to aid the reader's understanding of the embodiments of the present invention, and do not create limitations, particularly as to the position, orientation, or use of the invention unless specifically set forth in the claims. Joinder references (e.g. attached, coupled, connected, and the like) are to be construed broadly and may include intermediate members between a connection of elements and relative movement between elements. As such, joinder references do not necessarily infer that two elements are directly connected and in fixed relation to each other.

The above-described benefits, embodiments, and/or characterizations are not necessarily complete or exhaustive, and in particular, as to the patentable subject matter disclosed herein. Other benefits, embodiments, and/or characterizations of the present invention are possible utilizing, alone or in combination, as set forth above and/or described in the accompanying figures and/or in the description herein below.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and drawing figures are to be understood as being approximations which may be modified in all instances as required for a particular application of the novel assembly and method described herein.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description and in the appended drawing figures.

In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

What is claimed:

1. A method for fire suppression, comprising:
sensing one or more initial environmental parameters in an area of interest, wherein the sensing is performed by one or more sensors positioned within the area of interest;
recording the one or more initial environmental parameters in the area of interest;
engaging a fire suppression system if the one or more initial environmental parameters reach a pre-determined threshold, wherein the engagement of the system is based at least in part on the one or more sensed initial environmental parameters;
sensing one or more subsequent environmental parameters in the area of interest;
recording the one or more subsequent environmental parameters in the area of interest;
comparing the one or more subsequent environmental parameters in the area of interest against the one or more initial environmental parameters in the area of interest;
obtaining one or more differential numerical values, if any, of the environmental parameters after the comparison of the one or more subsequent environmental parameters in the area of interest is made against the one or more initial environmental parameters in the area of interest;
determining to continue engaging the fire suppression system based at least in part on the one or more differential numerical values of the environmental parameters.

2. The method of claim 1, wherein the initial and subsequent environmental parameters comprise humidity.

3. The method of claim 1, wherein the initial and subsequent environmental parameters comprise wind speed.

4. The method of claim 1, wherein the initial and subsequent environmental parameters comprise temperature,

5. The method of claim 1, wherein the initial and subsequent environmental parameters comprise presence of flames.

6. The method of claim 1, wherein the initial and subsequent environmental parameters comprise the amount of volatile organic compounds.

7. The method of claim 1, wherein the initial and subsequent environmental parameters comprise the amount of particulate.

8. The method of claim 1, wherein engaging the fire suppression system comprises increasing the relative humidity in the area of interest.

9. The method of claim 1, wherein engaging the fire suppression system comprises decreasing the temperature in the area of interest.

10. A system for fire suppression, comprising:
one or more sensors configured to sense initial and subsequent environmental parameters;
a vessel configured to hold fire suppression material;
a distribution system operatively connected to the vessel, positioned in a spaced apart relationship adjacent the area of interest, configured to deliver the fire suppression material from the vessel to the area of interest, when the fire suppression system is activated; and
a controller configured to engage or disengage the delivery of the fire suppression materials to the area of interest at least in part via the distribution system, based at least in part on the initial and subsequent sensed environmental parameters.

11. The system of claim 10, further comprising a power source to power the controller, one or more sensors, and/or the distribution system.

12. The system of claim 10, wherein the power source comprises a solar power system, comprising one or more solar panels, and one or more power storage devices.

13. The system of claim 10, wherein the initial and subsequent environmental parameters comprise humidity.

14. The system of claim 10, wherein the initial and subsequent environmental parameters comprise wind speed.

15. The system of claim 10, wherein the initial and subsequent environmental parameters comprise temperature,

16. The system of claim 10, wherein the initial and subsequent environmental parameters comprise presence of flames.

17. The system of claim 10, wherein the initial and subsequent environmental parameters comprise the amount of volatile organic compounds.

18. The system of claim 10, wherein the initial and subsequent environmental parameters comprise the amount of particulate.

19. The system of claim 10, wherein engaging the fire suppression system comprises increasing the relative humidity in the area of interest.

20. A method for fire suppression, comprising:
sensing one or more initial environmental parameters in an area of interest, wherein the sensing is performed by one or more sensors positioned within the area of interest;
recording the one or more initial environmental parameters in the area of interest;
engaging a fire suppression system if the one or more initial environmental parameters reach a pre-determined threshold, wherein the engagement of the system is based at least in part on the one or more sensed initial environmental parameters;
sensing one or more subsequent environmental parameters in the area of interest;
recording the one or more subsequent environmental parameters in the area of interest;
comparing the one or more subsequent environmental parameters in the area of interest against the one or more initial environmental parameters in the area of interest;
obtaining one or more differential numerical values, if any, of the environmental parameters after the comparison of the one or more subsequent environmental parameters in the area of interest is made against the one or more initial environmental parameters in the area of interest; and
determining to continue engaging the fire suppression system based at least in part on the one or more differential numerical values of the environmental parameters, wherein if the fire suppression system is engaged, a vessel configured to hold fire suppression materials distributes via a distribution system operatively connected to the vessel fire suppression material from the vessel to the area of interest.
